(19) United States
(12) Patent Application Publication
(10) Pub. No.: US 2007/0139626 A1
(43) Pub. Date: Jun. 21, 2007

(54) Cultural interactive panorama (culturama)

(75) Inventors: Fathi Hassan Saleh, Giza (EG); Mohamed Farouk Badawi, Giza (EG)

Correspondence Address: WOODCOCK WASHBURN LLP, CIRA CENTRE, 12TH FLOOR, 2929 ARCH STREET, PHILADELPHIA, PA, 19104-2891, US

(73) Assignee: Center for Documentation of Cultural and Natural Heritage, CULTNAT, Giza (EG)

(21) Appl. No.: 10/591,784

(22) PCT Filed: Feb. 26, 2005
(86) PCT No.: PCT/EG05/00007

§ 371 Date: Dec. 12, 2006

(30) Foreign Application Priority Data
Mar. 6, 2004 (EG) 2004030098

(51) Int. Cl. H04N 7/00; G03B 21/26

(52) U.S. Cl. 353/94; 348/36

(57) ABSTRACT

CULTURAMA is an innovative panoramic display using PC. A set of interactive multimedia programs related to Egyptian and Arabic heritage are displayed on a semi circular screen with a diameter of 10 meters. The display is achieved using 9 regular video projectors driven by a single personal computer.

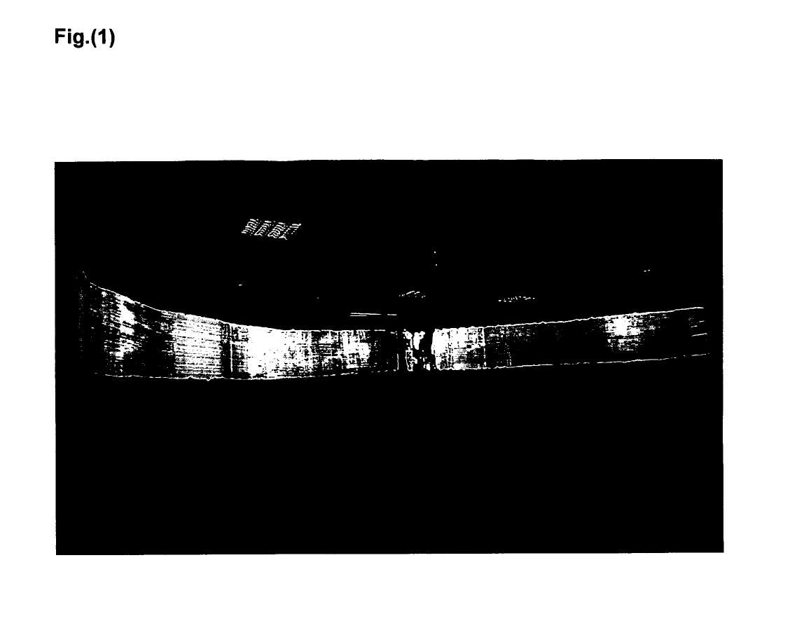

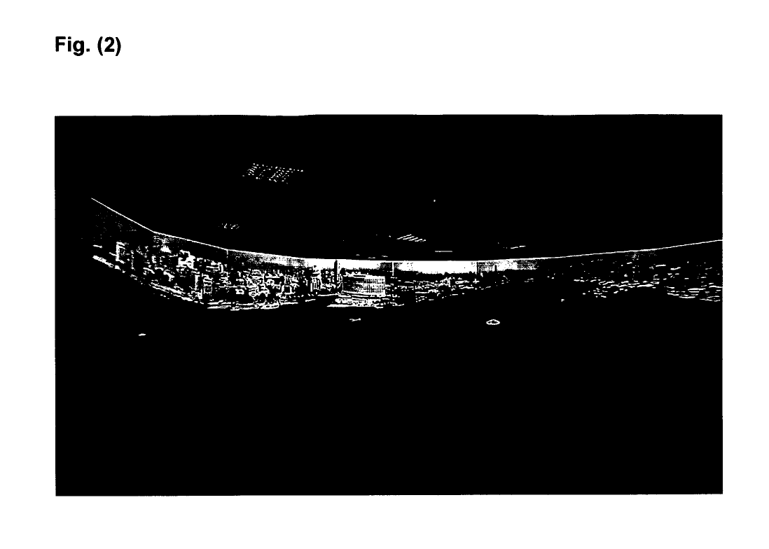

### TECHNICAL FIELD

Hardware and software that produce an interesting and interactive huge panoramic display.

### BACKGROUND ART

An interactive multimedia show on PC screen whose proportions 4:3
Video panoramic display
Video or cinema display show
Plasma screen display whose proportions 9:16
Using multiple PCs to display a show on multiple screens

### DISCLOSURE OF INVENTION

Introduction

CULTURAMA, Cultural Panorama, is an innovative harmonized mix between a wealth of cultural and natural heritage information, very informative and attractive multimedia program and latest display technology. CULTURAMA has proved to be an excellent tool for delivering information to all age groups: children and adults. CULTURAMA also enabled us to display information that could have never been displayed clearly using regular computer display systems.

CULTURAMA is the first fully interactive multimedia system on semicircular nine screens panoramic display with diameter of 10 meters or more for cultural and natural heritage. In addition, we have achieved a huge computer display area with the resolution 7200×600 pixels. This area is used to deliver wide range of information that could have never been delivered using standard computer display. Examples of such information are historical time lines, panorama of real scenes and sites, visual comparison between many items and the clear display of large objects. Moreover, we have introduced a new concept of multimedia development to utilize this huge display area. At last but not least, we have made use of regular equipments represented in regular workstations and regular video projectors in addition to implementing the semicircular screen using flat projection screens. The use of those familiar equipments made CULTURAMA: cost effective, easier to maintain, together with flexible and powerful software development. Also the use of flat projection screens facilitated image stitching with no need for special hardware.

CULTURAMA: Its Start and Development

In 2001, video walls technology was our main target for delivering information in an interesting way to different categories of audience. Unfortunately, we faced the following problems while studying such a solution: high cost, huge size of equipments, importability of the solution and limited resolution output. Afterwards, we came up with the idea of simulating the video wall by using regular PC together with multiple plasma screens, arranged in an array. We targeted an array of 2×2 screens, each is 61″. The main problem we had to solve was how to make the screens display a continuous image without loosing resolution in which each screen displays 800×600 pixels rather than dividing the computer output by 4. We started by investigating the availability of a commercial hardware that can take the computer display output and divide it into multiple outlets during which the total resolution is not limited to standard output resolution. Regrettably, such a solution was not applicable, thus we approached a second methodology. The main essence of this methodology was using different computers. Each computer is running a separate program and attached to one plasma. In fact, the key issue investigated was how to synchronize between the four computers so that the output would seem to be one image rather than being scattered between different computers. As a result, we connected the four computers with a LAN by which the four programs would be able to handshake to synchronize their output together. This approach would have worked fine except for two problems.

First, we intended to produce high-end multimedia display that requires a high level of animation. Meanwhile, this solution would result in having slight delay for handshake which cannot be eliminated which is considered unacceptable for impressive animations. The second problem was the complexity of the software development. Looking for solutions to these problems, a feature in MS Windows was discovered that solved all our problems, which is the ability of Windows to deal with multiple display outputs. MS Windows 2000 can support up to ten different display outputs; moreover, one can arrange these outputs to arbitrarily extend windows desktop. Based on this feature, we equipped a PC with four PCI VGA cards and arranged them to form a 2×2 array. Each output is 800×600 pixels, which means that the total resolution of the display is 1600×1200. Afterwards, we developed a single multimedia program with window size 1600×1200. Applying this method, we succeeded in having a video-wall like computer display making use of the full resolution of each display unit. In addition, developing a single program with the total resolution of the array enabled us to produce high end multimedia program with animations and effects which was applied to the four screens as a single display unit achieving an accurate synchronization between them.

The next stage of development started with the idea of achieving a real virtual visit to some ancient Egyptian tombs. These tombs usually consist of one or more small rooms (2m×2m on the average). The walls of each room contain different Pharaonic inscriptions. These tombs are scattered all over Egypt and many of them are not open for public. Consequently, simulating a real visit to these tombs would give people the opportunity to see these tombs. Out objective was to simulate the rooms using computer screens instead of the walls, electronic cave. We investigated ready made cave systems, but the main disadvantage was the limitation of using the special software for the cave system. Meanwhile, in our solution we use any development tool just taking into consideration the resolution of the output program. The use of such tools enables us to develop any type of application together with high programming capabilities. In order to achieve the cave we had to set up the screens in a rectangular shape with an open side to enable the audience to get in. The audience will view a computer generated image of the tomb walls around them in which one can navigate from one room to another. Moreover, extra levels of information would be added to the visit; for example, an English translation of the hieroglyphic text written on the walls. Using the methodology described above, it became very easy for us to develop this idea.

Starting the development of the cave, we noticed that the use of plasma screens will not be suitable for the new requirements. Basically, because of its small display area compared to tomb walls, high cost of using an array of plasmas for each wall, exceeding number of outputs supported by Windows and the unrealistic view of the wall that the borders of the plasmas give. As a result, we studied using video projectors instead which was considered an evolutionary point in the development of CULTURAMA because it added a lot of features and new ideas for development. The most important feature was the big display area that the project or can provide especially with the advancement in the projection technology that resulted in good quality image and small projector size. Furthermore, we used three regular projection screens arranged in U shape. Unfortunately, we faced another problem which was the limited area provided for audience, although we targeted large number of audience per show. This problem was solved thinking of different screens setup. We installed regular projector screens with angles of 135 degrees instead of 90 degrees Although this did not stimulate being in tombs, it was useful in displaying the walls of the tombs. During the development of the software we noticed that this setup can be used in displaying many types of information in an attractive way other than just simulating monuments walls.

Afterwards, we started to study using five screens instead of three. Lot of issues had to be put into consideration: Multimedia output performance, software development methodology for optimum utilization of the big display area, and hardware setup. We have installed the five screens to form a 90 degrees panorama, with an angle of 157.5 degrees between each two successive screens. The total output resolution was 4000×600 pixels. Currently, a permanent hall of 100 m² is dedicated for CULTURAMA at CULTNAT building located at the smart village, Egypt. After the three screens and the five screens display previously presented, a nine screens display is currently located at CULTNAT. The screens are arranged in a semicircular shape with a diameter of 10 meters. The hall is equipped to hold thirty five persons per show. Another CULTURAMA is currently running in the Library of Alexandria with a bigger hall and screens.

The following section will describe the details of CULTURAMA.

Hardware of CULTURAMA

We built CULTURAMA using very standard hardware components. The currently used hardware is as follows:
A workstation with dual 3.02 GHz Xeon processors, 2 GB RAM, 4PCI slots
Four dual outputs VGA cards 64 MB.
Nine ceiling mounted LCD projectors with luminance of 2200 ANSI.
Nine flat advertising stands 2.7m×2m to be used as projection screens.
Wireless mouse and keyboard.
Surround sound system 7.1

To achieve the panoramic display, the above mentioned components are installed together as follows:

First as for the screen setup, the nine flat screens are arranged to form a semicircle or an arc of a circle. To achieve this, the angles between each two successive screens have to be equal. Depending on the area of the hall in which CULTURAMA will be set, this angle varies from 22.5° for a semicircular screen shape to 16° for the largest arc. To obtain seamless screens we used advertisement stands with projection material instead of ad banners. The screen width also can vary to satisfy the space requirements. We have already used widths of 1.8 m, 2 m, and 2.3 m for each screen.

The projectors are ceiling mounted and arranged on an arc similar to the screen arc but with a smaller diameter. The diameter of the projector arc depends on the projector model and the screen width. Each projector is adjusted to project its image on a single screen of the nine. The ceiling mounting has to be flexible to adjust the projector position, horizontal angle, and vertical angle. These adjustments are very essential to produce accurately concatenated image.

The workstation display setup plays a very important role. Using the MS Windows extended desktop capability we were able to achieve an extended computer screen with the resolution of 7200×600. This setup is the key feature that enables the development of single software that runs on concatenated nine screens.

Software of CULTURAMA

As for the software development, the main idea is to develop a single multimedia interactive program with a screen size matches the total size of the nine screens together. This means a single program with the size of 7200×600 pixels. Few of the multimedia authoring tools can produce this output resolution so we are using Macromedia director to develop the software for CULTURAMA.

Although we are currently using CULTURAMA to deliver cultural information, the same system and methodology can be used to display a wide range of other information types.

Current Programs Displayed in CULTURAMA

CULTURAMA has three main sections, which represent three different periods of the Egyptian history. Those sections are Ancient Egyptian Period, Highlights of Coptic & Islamic Civilizations and Modern Egypt. In the first section, we introduce the Ancient Times by displaying the timeline of the Pharonic period starting from 3000 B.C. until the start of the Gregorian calendar. All the well-known kings are presented by a photo in which they are placed in their correct chronological position. Pointing to any of those kings, basic information is displayed, which represents the first level of information. Without CULTURAMA screen, one could have never been able to display such a timeline on a single screen. Furthermore, if the user wants to know more stories about specific kings, he can just click on this particular king where the second level of information is displayed. For example, Thotmosis III who built an outstanding room in the Karnak Temple, called the botanical garden. On the walls of this room, he has documented the natural elements known in Egypt at his time. By clicking Thotmosis III, the walls of the botanical garden are displayed giving the audience the chance to see all the animals, birds, and plants inscribed on the walls. Moreover, selecting any of these elements will display more information about it in which a recent photo of the bird or the plant is displayed together with description that is considered the third level of information.

Another section that can be reached from the time line is the Rhind mathematical papyrus (RMP), which is considered one of the most famous mathematical papyri from the time of Pharaohs. The RMP is five meters long and contains 86 different mathematical problems and their solutions. Using CULTURAMA enabled us to display RMP and to magnify it 3 times on one screen. Furthermore, users can interact with the papyrus to zoom into any of the problems in order to see the English translation of the hieroglyphic text.

Another key feature of CULTURAMA is the ability to display on it panoramic scenes of some places or sites. This technology is specifically used in Coptic & Islamic Civilizations the modern Egypt sections. For example in modern Egypt section, we currently display a panoramic view of Cairo from the Nile and Alexandria from the sea. Users can interact with the panorama to navigate or select some of the components in the view in order to see more information about this component, which is considered the second level of information in this section. For instance, in Cairo panorama you can click on one of the old bridges on the Nile to see a movie clip of that bridge filmed by the brothers Lumiere in 1895.

Development Methodology for CULTURAMA

The key factor for CULTURAMA success is the amount and the type of information it contains together with the methodology used to introduce this information. The content of CULTURAMA is a merge of information selected from our database built in the different programs of CULTNAT. This information is introduced to the audience in an interactive multimedia program that has been developed taking into consideration two important aspects of design. The first aspect is simplicity in delivering information while using multiple and latest multimedia technologies. The different technologies used are harmonized together in a perfect way in order to present cultural wealth in a very simple, impressive, clear and compact manner. On the other hand, the second aspect is the division of information into multiple levels: general and more specific ones.

Usage of CULTURAMA

A wide range of audience visited and watched CULTURAMA starting from children to highly educated people working in different fields with different nationalities. The feedback was amazing, Vinton Cerf, the senior vice-president of technology strategy, MCI, said “The CULTNAT projects may be the most important, historical, educational and technological efforts ever monumental in Egypt. They will cement the importance of Egyptian history and culture into the fabric of world history”. Moreover, displaying CULTURAMA to students and teachers, we discovered that it could be used as an attractive educational tool especially by giving children the opportunity to run the program. At the university level, lots of Professors in the fields of Culture and History requested to arrange some sessions in CULTURAMA in which they can bring their students to give them lectures using CULTURAMA. Moreover, cultural experts were impressed by the way the information can be presented on CULTURAMA as they started thinking about the usage of this type of display in their field. Museum design experts and museum managers also consider CULTURAMA as an essential element that should exist in every important museum. In fact, many IT Ministers who visited CULTURAMA from different countries were fascinated. In conclusion, CULTURAMA can be used for a very wide range of audience, and for lots of purposes.

### BRIEF DESCRIPTION OF DRAWINGS

Two photographs for CULTURAMA that show how the system looks like

1. A system capable of displaying interactive computer programs on a large area using nine flat screens to build single seamless customizable panoramic screen, depends on traditional technology and have the following advantages:
Simple to operate and maintain
Simple to install
The shape and area of the display are easily customizable
Can run any kind of visual contents, both self-running and interactive
Can be used in various applications like educational, technical and cultural
And is composed of:
a. Multiple projectors (the projection set) those project the panoramic image on the receiving set
b. Multiple screens (the receiving set) those are arranged seamlessly in front of the projection set
c. Single PC that runs the computer programs and connects to the projection set through a number of VGA cards

2. The projection set (according to claim 1), is composed of nine fixed projectors, each one projects a portion of the computer program on the opposite screen of the receiving set, resulting in seamless panoramic image of the computer program on the receiving set

3. The receiving set (according to claim 1), can be easily customized to produce differently shaped panoramic displays (straight, circular, semi-circular or any other shape) by adjusting the angle between each two successive screens

4. The projection set (according to claim 1), can be adjusted to produce panoramic displays those cover different field of views in the horizontal and vertical direction.

5. The displaying system (according to claim 1), is composed of regular, available and easy-to-use technologies making it a low-cost panoramic displaying system

6. The displaying system (according to claim 1), can display stereoscopic contents

7. The PC (according to claim 1), is connected to the projection set through five VGA cards, each can output to two projectors, and can run programs contain different types of visual contents

8. The program (according to claim 7), can contain both self-running and interactive contents

9. The program (according to claim 7), have an extremely hi resolution (7200*600 or higher)

10. The displaying system (according to claim 1), can be used to display different types of contents like: information, 2d and 3d animations, video, panoramic Images and real-time 3d graphics

11. The receiving set (according to claim 1), use flat screens to produce custom-shape panoramic display (linear, circular, semi-circular . . . )

12. A portable system capable of displaying interactive computer programs on a large area using nine flat screens to build single seamless customizable panoramic screen, depends on traditional technology and have the following advantages:
Simple to operate and maintain
Simple to install
The shape and area of the display are easily customizable
Can run any kind of visual contents, both self-running and interactive
Can be used in various applications like educational, technical, promotional and cultural
And is composed of:
a. Multiple projectors (the projection set) those project the panoramic image on the receiving set
b. Multiple screens (the receiving set) those are arranged seamlessly in front of the projection set
c. Single PC that runs the computer programs and connects to the projection set through a number of VGA cards
d. A hanging platform for the projection set that can be easily installed

13. The projection set (according to claim 12), is composed of nine fixed projectors, each one projects a portion of the computer program on the opposite screen of the receiving set, resulting in seamless panoramic image of the computer program on the receiving set

14. The receiving set (according to claim 12), can be easily customized to produce differently shaped panoramic displays (straight, circular, semi-circular or any other shape) by adjusting the angle between each two successive screens

15. The projection set (according to claim 12), can be adjusted to produce panoramic displays those cover different field of views in the horizontal and vertical direction.

16. The displaying system (according to claim 12), is composed of regular, available and easy-to-use technologies making it a low-cost panoramic displaying system

17. The displaying system (according to claim 12), can display stereoscopic contents

18. The PC (according to claim 12), is connected to the projection set through five VGA cards, each can output to two projectors, and can run programs contain different types of visual contents

19. The program (according to claim 18), can contain both self-running and interactive contents

20. The program (according to claim 18), have an extremely hi resolution (7200*600 or higher)

21. The displaying system (according to claim 12), can be used to display different types of contents like: information, 2d and 3d animations, video, panoramic images and real-time 3d graphics

22. The receiving set (according to claim 12), use flat screens to produce custom-shape panoramic display (linear, circular, semi-circular . . . )

23. The receiving set (according to claim 12), composed of multiple pop up flat screens those can be easily folded and unfolded

24. The hanging platform (according to claim 12), can be easily adjusted to have different projection sets (straight, circular, semi-circular or any other shape)

25. The hanging platform (according to claim 12), can be easily assembled and disassembled
